(19) United States
(12) Patent Application Publication
(10) Pub. No.: US 2005/0289045 A1
(43) Pub. Date: Dec. 29, 2005

(54) Systems and methods for automated loan processing and distribution using multiple channels

(75) Inventor: David R. Lawson, Dallas, TX (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Capital One Financial Corporation

(21) Appl. No.: 11/156,660

(22) Filed: Jun. 21, 2005

Related U.S. Application Data
(60) Provisional application No. 60/581,368, filed on Jun. 22, 2004.

(51) Int. Cl. G06F 17/60

(52) U.S. Cl. 705/38

(57) ABSTRACT

Multiple business channels are provided for a borrower to apply for an automobile loan and, in addition, multiple channels are provided for the distribution of loan funds for approved applications to borrowers. Through implementation of a network of partner lenders, a primary lender may offer a seamless integration of its loan products with partner lenders across multiple channels. A borrower may investigate automobile loan products, submit an application for an automobile loan, and receive a decision of whether or not the application was approved. For loans that are approved, the borrower may further commit to the terms to the loan, resulting in the production of a check that the borrower may use to purchase an automobile.

### RELATED APPLICATION

This application claims the benefit of priority from U.S. Provisional Application No. 60/581,368, entitled “Systems and Methods for Automated Loan Processing and Distribution Using Multiple Channels” filed Jun. 22, 2004, the disclosure of which is expressly incorporated herein by reference in its entirety.

### DESCRIPTION

### TECHNICAL FIELD

Embodiments consistent with the invention provide systems and methods for providing automated loan processing and distribution of loan funds using multiple channels. In particular, through implementation of a network of partner lenders, a primary lender may offer a seamless integration of its loan products with partner lenders across multiple channels.

### BACKGROUND

Typically, borrowers borrowing money to purchase a vehicle apply for a loan in one of several ways. For example, the borrower may apply by interfacing with an individual representing a lender, or may interact electronically over the Internet to submit information. At the end of these interactions, the borrower might receive a result indicating whether or not the loan was approved. However, typically, a lender is not able to offer to potential borrowers the opportunity to apply for a loan through multiple channels. This is due to various limitations, such as the fact that certain lenders may not operate in certain regions, for example.

In addition, once a borrower has applied for a loan in a particular manner, the borrower must continue the process in a similar manner. For example, using an Internet application, a borrower may apply for a loan online and supply identification information and employment information. In some situations, the borrower may receive a result informing the borrower whether the loan was approved or denied after the borrower has completed the application. The result may arrive in real time upon the completion of the application.

Alternatively, the borrower may receive an e-mail message or telephone call indicating whether the loan was approved or denied. In any event, when the borrower applies electronically and receives an approval, the borrower will still receive a check several days later via mail. Similarly, if a borrower applies over the telephone, the borrower will need to wait until a check arrives in the mail. As a result, it is not possible for a borrower to apply using one channel (such as over the Internet) and then pick up a check the same day using a different channel (such as in person at a bank). Moreover, it is not possible for the borrower to switch channels at any stage of the process or to access a different lender to continue the same loan application.

### SUMMARY

Consistent with the principles of the present invention, systems and methods provide a primary lender with the ability to partner with other lenders to form a network to offer multiple channels through which a borrower may apply for an automobile loan. A borrower may change channels at any stage of the loan process, which may result in the borrower re-entering the process through a different channel that may or may not be operated by the same lender.

Systems and methods consistent with the present invention provide multiple business channels for the distribution of loan funds for approved applications to borrowers. A borrower may investigate automobile loan products, submit an application for an automobile loan, and receive a decision of whether or not the application was approved. For loans that are approved, the borrower may further commit to the terms to the loan, resulting in the production of a check that the borrower may use to purchase an automobile.

Consistent with an embodiment of the present invention, a method is provided for automatically distributing a loan to a borrower using a data processing system. Data is received over a network for a loan application that is provided by the borrower. The data is automatically analyzed using a computer, which determines whether the loan is approved. When the loan is approved, a location where the borrower may pick up a loan check based upon a present location of the borrower is determined.

Consistent with another embodiment of the present invention, a system is provided for automatically distributing a loan to a borrower. The system comprises a network and a server coupled to the network that receives data for a loan application. A decisioning module executes instructions on the server to automatically analyze the data to determine whether the loan is approved and, when the loan is approved, determines a location where the borrower may pick up a loan check based upon a present location of the borrower.

Consistent with another embodiment of the present invention, a method is provided for offering loans to a borrower through multiple channels using a data processing system. The method comprises providing multiple channels for a borrower to access one or more lenders; receiving a first portion of loan application data from the borrower over a first channel using a computer; and receiving a second portion of loan application data from the borrower over a second channel.

Consistent with yet another embodiment of the present invention, a system provides multiple channels for a borrower to access one or more lenders. The system comprises a network and a computer. The computer executes instructions to receive a first portion of loan application data from the borrower over a first channel. The computer further executes instructions to receive a second portion of loan application data from the borrower over a second channel.

### BRIEF DESCRIPTION OF THE DRAWINGS

The accompanying drawings, which are incorporated in and constitute a part of this specification, illustrate embodiments consistent with the invention and, together with the description, serve to explain the principles of the invention. In the drawings:

FIG. 1 shows examples of the channels that a primary lender may provide to borrowers that are applying for a loan;

FIG. 2 shows an exemplary flow diagram of steps taken when a borrower switches from one channel to another during the application process;

FIG. 3 shows an exemplary flow diagram of steps when a borrower seamlessly switches between partner lenders;

FIG. 4 shows an exemplary flow diagram of steps taken to apply for a loan consistent with an embodiment on the present invention;

FIG. 5 shows an exemplary flow diagram of steps taken to process and decision an application that are consistent with an embodiment of the present invention;

FIG. 6 shows a flow diagram of steps taken to distribute funds to the borrower that are consistent with an embodiment of the present invention; and

FIG. 7 is an exemplary system consistent with the present invention.

### DESCRIPTION OF THE EMBODIMENTS

Consistent with the principles of the present invention, systems and methods provide a primary lender with the ability to partner with other lenders to offer multiple channels through which a borrower may apply for or receive an automobile loan. For example, a borrower may change channels at any stage of the loan process, which may result in the borrower re-entering the process through a different channel that may or may not be operated by the same lender.

Broadly described, a borrower may investigate automobile loan products, submit an application for an automobile loan, and receive a decision of whether or not the application was approved. For loans that are approved, the borrower may further commit to the terms to the loan, resulting in the production of a check that the borrower may use to purchase an automobile. The account upon which the check is drawn is funded with the proper amount and serviced. The “servicing” of the account refers to the time period during which the loan is in repayment. Throughout the process, customer support is available at any stage when needed by the borrower.

Furthermore, at any point in the process, the borrower may switch between multiple channels. By multiple channels, it is meant that a particular lender provides more than one channel for borrowers to apply for a loan. In addition, multiple channels are available for borrowers to receive a check in the amount of the loan. The overall process is flexible in that the channel used by a borrower to apply for a loan and the channel used by a borrower to receive a check may differ. In addition, the lender providing the funds and servicing the loan need not operate each channel used by a particular borrower.

For example, a primary lender may operate the channel used by a borrower to apply for a loan and a different lender may operate the channel used by the borrower to receive the check. Such an implementation is arranged by virtue of a partnership between a primary lender and other lenders, such as banks with branch offices throughout a region, state, or country. Accordingly, by partnering with other institutions, such as banks, stores, and the like, the primary lender may offer its loan products in establishments operated by other companies. The primary lender may offer loan products through multiple entities that each provide multiple channels of access, thus maximizing the number of ways a borrower may access the loan products.

Multiple Channels of Interaction

Reference will now be made to exemplary embodiments of the invention, examples of which are illustrated in the accompanying drawings. Wherever possible, the same reference numbers will be used throughout the drawings to refer to the same or like parts.

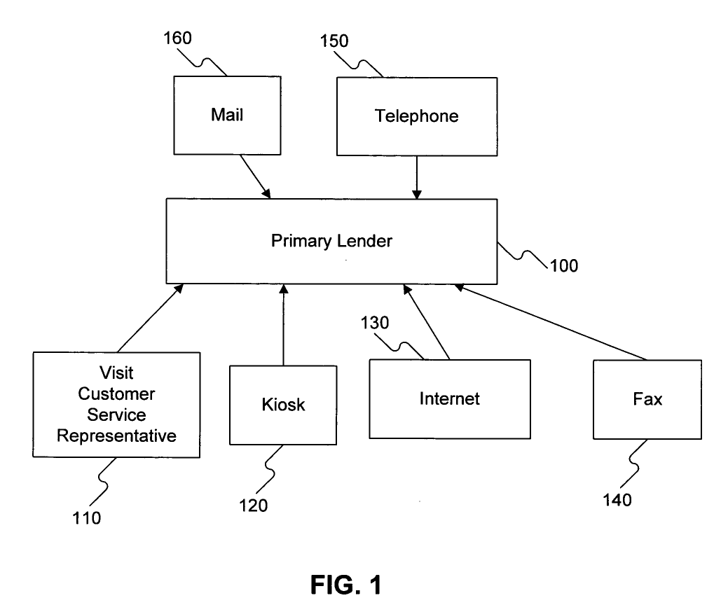

FIG. 1 shows examples of the channels that a primary lender 100 may provide to borrowers that are applying for a loan. For example, a borrower may apply at a bank branch office by interacting with customer service representative 110; by using kiosk 120 at a bank branch office or other location; by accessing Internet website 130 using, for example, a computer or a PDA; by sending an application by facsimile 140; using telephone 150 to speak with a customer service representative or to interact with a voice activated response system; or by sending an application via mail 160.

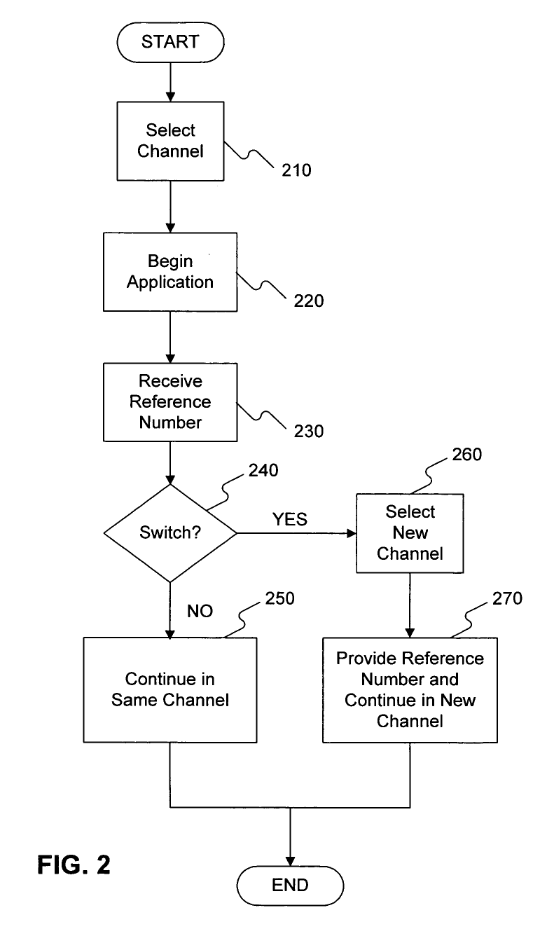

FIG. 2 shows a flow diagram of a method, consistent with an embodiment of the present invention, by which a borrower may switch from one channel to another during the application process. In particular, at any stage of the application process, a borrower has the option to switch to a different channel. For example, a borrower may select a particular channel, such as by interacting over the phone, in person, applying via Internet, or using a PDA, for example. Step 210. Next, the borrower may begin the application process. Step 220. After beginning the application, the borrower may receive a reference number identifying the application. Step 230. The borrower may then make decision to switch to a different channel. Step 240.

If the borrower decides to switch to a different channel, the borrower may select the new channel. Step 260. After selecting the new channel, the borrower, may be asked to submit the reference number so that the borrower can continue the same application. Step 270. For example, a borrower could start an application over the Internet in the morning, and, later in the day, could contact a customer service representative. Using the application reference number, the information previously submitted is available to the customer service representative and used to continue the process, facilitating a seamless switch from one channel to another with minimal effort by the borrower. However, should the borrower decide to remain in the same channel, the borrower may continue the application process without making such a switch. Step 250.

Partner Lenders

In addition to providing multiple channels for interacting with borrowers, embodiments consistent with the present invention provide a multi-company distribution system premised upon partnerships between a primary lender and partner lenders. For example, a primary lender implementing a system consistent with the principles of the present invention may offer partner lenders, such as banks, the ability to provide automobile loans using the primary lender's loan decisioning systems and other related services, such as customer support.

As a result, a partner lender may customize its loan process as desired when partnering with the primary lender. By partnering with other lenders, the primary lender may access a greater number of markets by creating multiple access points to different channels through a network of partner lenders. Such an arrangement provides each partner lender with a spectrum of channels from which each partner lender may select. In addition, each partner lender may also customize the manner in which it interacts with borrowers. “Interaction” refers to a particular manner in which potential borrowers may enter the loan process, apply for a loan, receive information related to a loan application such as customer service, and receive loan funds after the application is approved.

Such “plug and play” capability therefore allows each partner lender to efficiently select the options it desires to offer. In so doing, a partner lender can select from multiple channels which channels it wishes to make available to its customers. The partner lender may also customize each channel to operate in a certain manner. For example, a partner lender may decide to offer loan products through its bank branch office. The same partner lender may also offer loan products via applications received over the Internet. A different partner lender may offer loan products via facsimile, via mail, and by telephone.

In the example of a partner lender offering loan products over the telephone, the partner lender may also further customize the manner in which the Internet is made available to borrowers. For example, consider the case of partner lender that is a bank operating its own website. The bank may want to provide a hypertext link on its website to send borrowers directly to the primary lender's website to complete an application. Alternatively, a different partner lender with its own website may want to have the website functionality for applying for a loan appear directly on its website. In such a case, the website branded as the partner bank would load webpage data necessary for collecting application information from a server maintained by the primary lender. In another alternative, the website can be co-branded and the primary lender's website may load into a frame and be displayed as a portion of the bank's website.

Partner lenders may also decide to offer some options and not to offer other options. For example, a particular partner lender may only offer loans at its bank branches. Another partner lender might only offer loans from the Internet because it does not have customer service representatives available or trained to offer the loan products. When each partner lender establishes a relationship with the primary lender, it may select the options it would like to provide and may also customize how each option is provided.

In the case of a partner lender offering loan products over the telephone, the partner lender may select how interactions are handled. When a borrower dials a toll free number to ask questions about a loan, the partner lender may specify in advance how that borrower's call will be handled. The partner lender may select from a list of options, including whether it would like the borrower to reach its own customer service representative, or whether it would like the call to be sent to a customer service representative employed by the primary lender.

The partner lenders also specify other options, such as the duration of time before an approved borrower receives a check. Partner lenders may also specify the locations checks may be made available for printing. Still further partner lenders may specify the number of days that checks will remain valid. One of skill in the art will recognize that partner lenders may specify a variety of options in keeping with the spirit and scope of the present invention.

Partner lenders can also choose which borrowers will enter into an interaction with the loan processing and decisioning system implemented by the primary lender. For example, a particular partner lender may already offer its customers automobile loans. However, the partner lender may not underwrite loans for a particular segment of the market to avoid the associated risks with such loans. In such a situation, the partner lender may refer borrowers that have not met its lending criteria to the primary lender. The referral may occur in several ways. For example, if a borrower is applying at the partner lender's website and does not receive an approval for a loan, the borrower's application may be automatically forwarded to the primary lender, which may decision the application. The primary lender may send a result directly to the partner lender, which may then approve the loan using the primary lender's decision. Alternatively, the partner lender's website may simply present a message to the borrower that a loan may be available at a partner's website, and may provide a link or automatically forward the borrower to the primary lender's website. Because the application has already been completed, any further decisioning or processing may retrieve the stored application data for further decisioning or processing.

Seamless Switching Between Channels and Partner Lenders

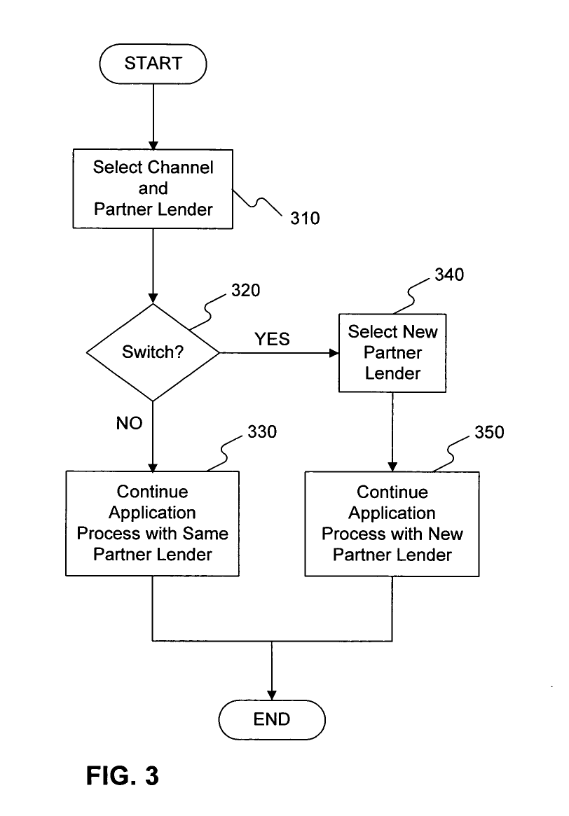

FIG. 3 shows an exemplary flow diagram of a method, consistent with an embodiment of the present invention, by which a borrower seamlessly switches between partner lenders. As discussed above, each partner lender can specify which channels it wants to make available at each step or stage of the process, and the borrower can switch seamlessly from one channel to another.

Moreover, the borrower can switch from one partner lender to another partner lender. For example, when a particular partner lender does not have a bank branch in a particular location, and another partner lender does, a borrower may switch to a different partner lender. Initially, a borrower may select a channel and a partner lender to being the application process. Step 310. At the borrower's request, the borrower may ask to switch to a different channel. Step 320. If the different channel is not supported by the existing partner lender, a new partner lender may be selected. Step 340. Once the new partner lender is selected, the borrower then continues the application process in the new channel. Step 350. However, if the newly selected channel is supported by the existing partner lender, the borrower may continue the application process with the same partner lender. Step 330.

The following is provided as an example. Consider a borrower interacting with a customer service representative in a bank. Later, if the borrower has questions, the borrower can call a toll free number to interact with a customer service representative of the primary lender. The customer service representative may answer the call in a manner proscribed by the partner lender. This option is appropriate for banks that may not have customer service representatives trained for the offered loan products. Such a bank might not offer its own customer service representatives channel and might instead use the primary lender's customer service representatives. Alternatively, the bank may direct customers to a different partner lender to have borrower questions answered. By providing the ability to switch from one channel to another, and across different partner lenders, to the borrower, the process operates in a seamless fashion. From the borrower's perspective, it is as if the borrower has interacted with one entity and one application throughout the process.

Application Processing

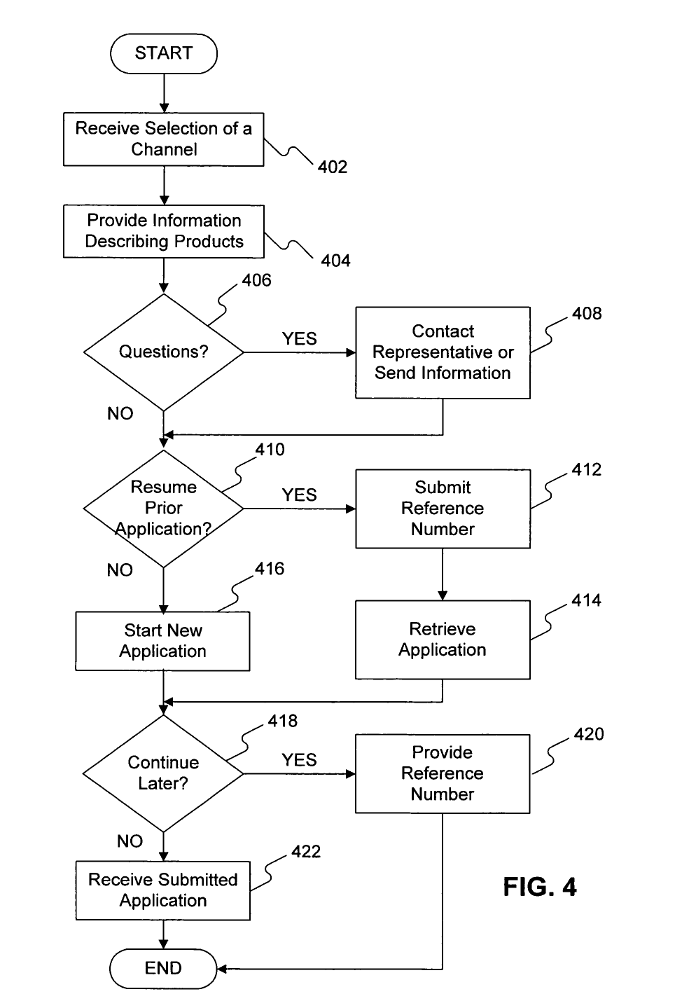

FIG. 4 shows an exemplary flow diagram of a method for applying for a loan consistent with an embodiment on the present invention. First, a lender may receiver a borrower selection of a channel to begin the processing of a loan application. Step 402. Some channels in a particular area or region may be available from multiple partner lenders. For example, a borrower may apply for a loan using a kiosk located at a location, such as a bank's branch office. Alternatively, the borrower may apply using an Internet website operated by the primary lender or by one of various partner lenders. The borrower may operate a personal computer or handheld device with an Internet connection. In yet another alternative, the borrower may apply in person by interacting with a customer service representative at a bank branch. In another alternative, the borrower may apply by dialing a telephone number to speak with a customer service representative associated with the primary lender or by using an interactive voice response application. In yet another alternative, the borrower may apply using printed materials available at a bank branch. For example, one way to investigate loan products is by using the kiosk channel. To do so, the borrower may go to a bank branch location where a kiosk is located. One of skill in the art will recognize that the kiosk may be located in various settings and that the use of a bank is merely exemplary. For example, kiosks may be located at a shopping mall, inside a car dealership, or inside any appropriate business environment.

After receiving the selection of a channel, the lender may provide information to the borrower describing automobile products. Step 404. The borrower may begin a session using the kiosk by using a pointing device, keyboard, or through voice activation or a touch screen display. The kiosk may be connected to a network, including the Internet, to retrieve information and/or webpages from a server located in a different location. They borrower may then consider and investigate the loan products being offered.

For example, when a borrower directly accesses a website, the borrower may navigate to an appropriate website using a personal computer, a PDA, or other handheld device. Once at the website, the borrower may read information describing the loan products in a manner similar to that described above in connection with the kiosk.

As another example, when a borrower travels to a bank to apply in person, the borrower may speak with a bank customer service representative to determine the loan products that are available. In a situation where the borrower goes to a bank, the bank may be in a partnership arrangement with the primary lender.

As yet another example, when a borrower uses the telephone to apply, the borrower may call an appropriate telephone number, such as a toll free number, to speak with a customer service representative. Alternatively, the borrower may to interact with an automated system via voice-activated commands or by entering appropriate numbers in response to question prompts.

As still yet another example, when a borrower applies in person at a bank, the borrower may also apply by picking up printing materials, which the customer may read and complete at the bank, or may return to the bank in person or through the mail at a later time.

In any of the above-described channels (kiosk, website, bank customer service representative, or telephone), should the borrower have any questions about the loan products being offered, the borrower may seek answers to the questions in one or more ways. Step 406. For example, when a borrower accesses a kiosk, at any stage in the process, the borrower may make a selection of the display to access a list of frequently asked questions (FAQ) or the kiosk may provide a telephone connection or voice over IP capability to allow the borrower to speak with a customer service representative. Step 408.

In the event that the borrower is accessing a website, in a similar manner, the lender may transmit to the borrower information when the borrower selects a FAQ link, or alternatively, the lender may provide information over a telephone through a customer service representative. When a borrower is speaking with a customer service representative at a bank, the borrower may direct questions to the representative. Similarly, during a telephone conversation with a customer service representative, the borrower may ask any questions, or when using an automated system, may speak an appropriate command or press an appropriate telephone key to speak with a representative.

The lender may also inform the borrower of a prior application if one has already been started and may prompt the borrower to resume the prior application. Step 410. For example, should the borrower have already begun an application through any channel, the borrower may be promoted to provide an application reference number. Step 412. After providing the application reference number, the application that the borrower had begun to fill out may be accessed over a network. Step 414.

Alternatively, once the borrower has selected a particular loan product, the lender may prompt the borrower to begin a new application. Step 416. For example, when a borrower applies for a loan using a kiosk or through a website, the borrower may complete various forms by using, for example, a computer keyboard and mouse. In other implementations, the kiosk or website may be voice activated and the borrower may simply speak answers to questions. During this step, the borrower may provide identification information, such as the borrower's name, address, phone number, e-mail address, and social security number, etc. Additionally, the borrower may be prompted to provide employment information, such as borrower's field of employment and salary. The borrower is also requested to provide the amount of the loan. Optionally, the borrower may provide the name of the dealership, if known, where the borrower intends to purchase the vehicle.

In the event that the borrower had previously begun an application from the same channel or a different channel at a different time, the borrower may continue that application. Much in the same way a primary lender may offer multiple channels through which borrowers may access loan products, the primary lender may also provide borrowers with the ability to switch from one channel to another in a seamless fashion after the borrower has begun the process of applying for an receiving a loan. In addition, the borrower may switch from one partner lender to another, and may also switch to and from services operated by the primary lender.

For example, continuing with the above process, a borrower may begin applying for a loan over an Internet website. After beginning the application, the borrower may decide to terminate the Internet session and continue later. Step 418. If the borrower decides to stop, at the conclusion of the Internet session, the borrower is given an application reference number. Step 420. At a later time, should the borrower desire to continue that application, by using the application reference number, the borrower may continue via the Internet website as well as through any other channel. For example, the borrower may decide to go to a bank to apply in person. Alternatively, the borrower may decide to use a kiosk at a bank. Or the borrower may decide to complete the application by telephone. In any of these cases, the borrower may provide the application reference number to continue the application at any channel at a later time. In the event that the borrower is in person at a bank, the information provided by the borrower will be converted into electronic form. As noted, any of the above switches from one channel to another may also involve the borrower switching from the primary lender and/or partner lender to another.

Alternatively, once the borrower has completed the application and submitted it for approval, the lender may receive the completed application. Step 422.

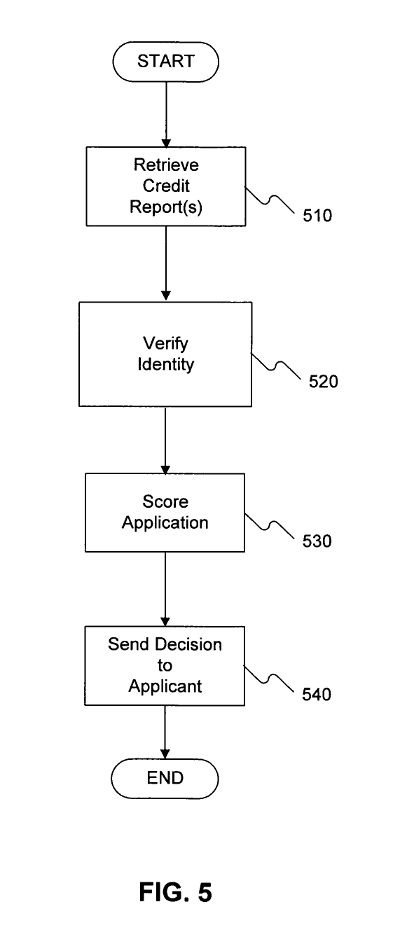

FIG. 5 shows an exemplary flow diagram of steps taken to decision an application that are consistent with an embodiment of the present invention. Using information provided by the borrower, one or more credit reports are electronically retrieved. Step 510. To verify the identity of the borrower, a decisioning module compares information provided by the borrower and information retrieved from the credit report. Step. 520. For example, after retrieving the credit report, a decisioning module may check to determine whether the social security number provided by the application matches the one retrieved from the credit report. In addition, the decisioning module may compare other information retrieved from the credit report with information provided by the borrower.

The decisioning module determines whether or not to approve the loan by scoring the application. Step 530. The decisioning module scores the application by processing the information received from the borrower and the information retrieved from the credit report by using one or more credit models. The credit models may be specific to a particular region of the country, to a particular income level, or other criteria. Each credit model provides a means for scoring the application by assigning, for example, weighted values to certain characteristics, such as the borrower's salary, and the borrower's pending credit debts.

The credit model arrives at a particular score, which indicates whether or not the application is approved. The result is then communicated to the applicant via a notification module. Step 540. If the application is not approved, the borrower may receive an e-mail, telephone call, or letter sent in the mail indicating the status of the loan. In such a situation, the borrower, when using a kiosk or accessing a website, may receive a message on a display indicating that they will receive a decision through one of the aforementioned means. Alternatively, the decision may be provided on a display in real-time, upon the completion of the application.

After submitting an application over a webpage, the borrower may receive a notification via the notification module that the loan was approved. At this point in time, the borrower may end the Internet session and is provided an application reference number. At a later time, the borrower may resume the Internet session and continue. Or, at a later time, the borrower may continue the process through a different channel, such as by traveling to a bank branch to use a kiosk or to interact with a customer service representative at the bank. Once at the kiosk or upon speaking with a customer service representative, the borrower may provide the application reference number to continue.

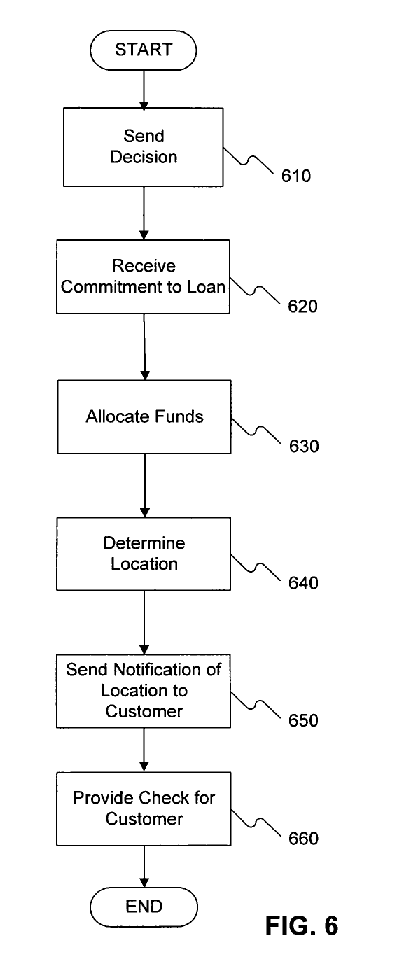

FIG. 6 shows a flow diagram of a method, consistent with an embodiment of the present invention, by which steps are taken to distribute funds to the borrower. When a loan is approved, the lender may transmit a real-time result of the approval to the borrower by displaying a message on a kiosk display or a webpage. Step 610. For an approved loan, the customer may be given the opportunity to commit to the loan after receiving the decision. Step 620. To commit to a loan using a kiosk, the borrower may be given the opportunity to review the amount of the loan, as well as the terms of the loan, such as the interest rate, repayment period, and other associated terms. The borrower may then click on an appropriate selection to confirm the loan and commit, or speak an appropriate command. Similarly, in a website environment, the borrower may select a confirmation command. Information indicating the borrower has committed to the loan is then transmitted to the lender.

Once a borrower has committed to the loan, the lender may make the funds available. Step 630. Funds can be made available in multiple ways. For example, the lender may transmit a message to the borrower indicating that the funds are being deposited into an account, being transferred electronically (electronic funds transfer), or being provided via a check.

For an approved loan, the decisioning module next determines an appropriate location where the borrower can pick up a check. Step 640. In the event that a check is being used as a means for providing the funds, the borrower may pick up the check according to the following steps. In determining the bank branch, the automated system may determine an appropriate branch for pickup of the check in one of several manners. For example, the automated system may determine the closest bank branch to the borrower's home address. Alternatively, the borrower may specify the address of the car dealership where the borrower intends to purchase the vehicle. The automated system may then compute the closest bank branch to the dealership. Alternatively, the automated system may determine the closest bank branch where the customer already has an existing check or savings account. In determining the location, the automated system may also take into account operating hours at particular branches to ensure that the borrower may travel to the location prior to closing to receive the check.

The determination of the location for check pickup may take into consideration several factors. For example, the system may determine the closest bank branch to the borrower's current location, the closest bank branch to the dealership where the borrower intends to purchase the vehicle, or the closest bank branch where the borrower already has an existing account. In addition, the system may determine the operating hours of the location.

In addition, the system may prompt the borrower for a preference of where the borrower would like to pick up the check. The borrower may select that the pick should be made available at the closest bank branch to the borrower's home address. Alternatively, the borrower may specify the address that the borrower is applying from, such as an office, so that the system may compute the closest bank branch to the borrower's present location.

As another alternative, the borrower may select an option to pick up the check at a bank branch that is closest to the dealership where the borrower intends to purchase the vehicle. As yet another alternative, the borrower can specify that the check should be made available at a bank branch where the borrower already has an existing account and/or banking relationship.

Next, the borrower receives from the lender a notification that is transmitted, for example, by the notification module, of a location where the check is available for pickup. Step 650. The notification may include a map or directions to the location, along with the location's operating hours. In addition, the borrower is provided with a application reference number, which is used to pick up the check on the same day that the borrower received approval of the loan.

The lender may make the check available for retrieval by the borrower in several ways. Step 660. First, if available, the borrower may use a kiosk at the bank to enter the borrower's name and application reference number. The kiosk may then print out the check. Alternatively, the borrower may interact with a bank representative, provide the bank representative with the borrower's name and application reference number, and the bank representative may operate a terminal to print out the check. The check may include an expiration date on it such that the borrower must purchase the vehicle in the next few days, for example. If the borrower did not specify a dealership, the payee of the check is left blank and can be completed by the borrower.

In the instances where borrowers travel to bank locations to pick up their checks in person, bank customer service representatives may also complete the verification of appropriate documents for identity and fraud prevention purposes. In addition, language on the check may bind the dealership, as a condition of accepting the check, of requiring the dealership to forward the title to the vehicle to the lender. With the check in hand and available funds to purchase the vehicle, the borrower may then go to a car dealership and purchase a car, and the process terminates.

Moreover, the need for checks can be completely eliminated in keeping with the spirit and scope of the present invention. In particular, at the conclusion of an Internet session or telephone call where a borrower's loan was approved, the funds may be transferred into an account electronically. Using electronic funds transfer (EFT), the loan may be provided to the borrower's account. Alternatively, the loan may be provided to the car dealership or automobile manufacturer's account. In another alternative, the funds may be made available through use of an existing or new credit card. Such transfers may also include a password, which may be required for the funds to be accessed. The password may be provided upon the transfer of the funds.

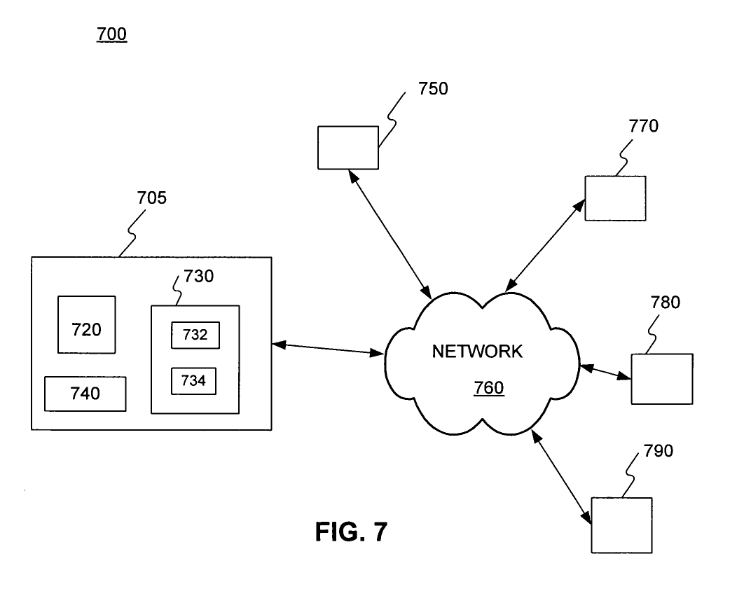

FIG. 7 is a diagram of an exemplary system 700, consistent with an embodiment of the invention, to implement the steps described above in FIGS. 1-6. System 700 includes a server 705, with a CPU 720, a memory 730, and a storage media 740, connected to a network 760. Software in memory 730 preferably implements a program for processing a loan application and for providing a determining of a location to pick up a loan check. For example, memory 730 may store a decisioning module 732 executing instructions for processing a loan application and determining a location where a borrower may receive loan funds. Memory 730 may also include a notification module 734 executing instructions for transmitting notifications to the borrower over network 760. Network 760 provides communications between the various components in system 700, such as user terminals 770-790. Network 760 may be a shared, public, or private network and encompass a wide or local area.

Terminals 770-790 allow a user to send and/or receive information to/from server 705. Terminals 770-790 may be any type of appropriate device for communicating with server 705 over network 760. For example, terminal 770 may be a PDA running a program for communicating with server 705, while terminal 780 may be a desktop computer running a web browser for communicating with sever 705 via the Internet. Optionally, terminal 790 may be a standard landline telephone or a wireless phone.

A borrower may access server 705 via network 760 or operate a web browser or software running on terminal 780. Data may be sent over network 760 to and from server 705 to terminal 780 during the application process. Alternatively, a borrower at terminal 790 operating as a telephone may contact a customer service representative at a terminal 750. The customer service representative may make selections using software running on terminal 750, and may send data to and from server 705.

The foregoing descriptions have been presented for purposes of illustration and description. They are not exhaustive and do not limit the invention to the precise form disclosed. Modifications and variations are possible in light of the above teachings or may be acquired from practicing of the invention. For example, the described implementation includes software but the present invention may be implemented as a combination of hardware and software or in hardware alone.

Additionally, although aspects of the present invention are described as being stored in memory, one skilled in the art will appreciate that these aspects can also be stored on other types of computer-readable media, such as secondary storage devices, like hard disks, floppy disks, or CD-ROM; a carrier wave from the Internet or other propagation medium; or other forms of RAM or ROM. The scope of the invention is defined by the claims and their equivalents.

Other embodiments of the invention will be apparent to those skilled in the art from consideration of the specification and practice of the invention disclosed herein. The specification and examples should be considered as exemplary only, with a true scope and spirit of the invention being indicated by the following claims.

1. A method for automatically distributing a loan to a borrower using a data processing system, the method comprising:
receiving data over a network for a loan application that is provided by the borrower;
automatically analyzing the data using a computer;
determining, by the computer, whether the loan is approved; and
determining a location where the borrower may pick up a loan check, based upon a present location of the borrower, when the loan is approved.

2. The method of claim 1, further comprising:
transmitting a notification to the borrower of the determined location.

3. The method of claim 2, wherein the notification is transmitted to the borrower via an e-mail message.

4. The method of claim 2, wherein the notification is transmitted to the borrower by a telephone call.

5. The method of claim 1, further comprising:
determining alternative locations where the borrower may pick up the loan check; and
transmitting a notification of the alternative locations to the borrower.

6. A system for automatically distributing a loan to a borrower, the system comprising:
a network;
a server coupled to the network that receives data for a loan application; and
a decisioning module executing instructions on the server to automatically analyze the data to determine whether the loan is approved and, when the loan is approved, to determine a location where the borrower may pick up a loan check based upon a present location of the borrower.

7. The system of claim 6, further comprising a notification module that executes instructions to transmit a notification of the determined location to the borrower.

8. The system of 6, wherein the notification module further executes instructions to transmit the notification to the borrower via an e-mail message.

9. The system of claim 6, wherein the notification module further executes instructions to transmit the notification to the borrower by a telephone call.

10. The system of claim 6, wherein the decisioning module further determines alternative locations where the borrower may pick up the loan check and the notification module transmits a notification of the alternative locations to the borrower.

11. A method for offering loans to a borrower through multiple channels using a data processing system, the method comprising:
providing multiple channels for a borrower to access one or more lenders;
receiving a first portion of loan application data from the borrower over a first channel using a computer; and
receiving a second portion of loan application data from the borrower over a second channel.

12. The method of claim 11, wherein the first channel is operated by a first entity and the second channel is operated by the first entity.

13. The method of claim 11, wherein the second channel is operated by a second entity.

14. The method of claim 11, wherein the computer comprises at least one of a desktop computer, a kiosk, or a handheld PDA device.

15. The method of claim 11, further comprising:
receiving over a network a submission of a loan application from the borrower;
determining, using a computer module, whether the loan is approved;
determining a location where the borrower may pick up a loan check when the loan is approved; and
transmitting a notification to the borrower of the determined location.

16. A system for providing multiple channels for a borrower to access one or more lenders, the system comprising:
a network; and
a computer, the computer executing instructions to receive a first portion of loan application data from the borrower over a first channel and to receive a second portion of loan application data from the borrower over a second channel.

17. The system of claim 16, wherein the first channel is operated by a first entity and the second channel is operated by the first entity.

18. The system of claim 16, wherein the second channel is operated by a second entity.

19. The system of claim 16, wherein the computer comprises at least one of a desktop computer, a kiosk, or a handheld PDA device.

20. A method for providing a loan to a borrower using a data processing system, the method comprising:
receiving data over a network for a loan application through a first channel;
automatically analyzing the data; and
supplying loan funds to the borrower over a second channel.

21. The method of claim 20, wherein the first channel is operated by a first entity and the second channel is operated by the first entity.

22. The method of claim 20, wherein the second channel is operated by a second entity.

23. A method for providing a loan to a borrower, the method comprising:
receiving data over a network for a loan application through a first channel;
automatically analyzing the data using a decisioning process implemented by a server operated by the first channel; and
automatically transmitting the received data to a second channel over the network when the loan is not approved by the first channel.

24. The method of claim 23, further comprising:
automatically analyzing the data using a decisioning process implemented by the second channel; and
automatically transmitting a decision over the network from the second channel to the first channel.
